(19) United States
(12) Patent Application Publication
(10) Pub. No.: US 2015/0195756 A1
(43) Pub. Date: Jul. 9, 2015

(54) MOBILE STATION DEVICE, BASE STATION DEVICE, COMMUNICATION METHOD, AND RECORDING MEDIUM

(71) Applicant: Sharp Kabushiki Kaisha, Osaka-shi, Osaka (JP)

(72) Inventors: Shusaku Fukumoto, Osaka-shi (JP); Shuichi Takehana, Osaka-shi (JP); Toshiaki Kameno, Osaka-shi (JP); Hidenobu Fukumasa, Osaka-shi (JP); Yuichi Nobusawa, Osaka-shi (JP)

(21) Appl. No.: 14/410,683

(22) PCT Filed: Jun. 11, 2013
(86) PCT No.: PCT/JP2013/066067

§ 371 Date: Dec. 23, 2014

(30) Foreign Application Priority Data
Jun. 28, 2012 (JP) 2012-145461

(51) Int. Cl. H04W 36/00; H04W 12/08

(52) U.S. Cl. CPC H04W 36/0061; H04W 12/08; H04W 36/36

(57) ABSTRACT

A mobile station device includes a peripheral regulated state acquirer configured to acquire regulated states of peripheral cells, a cell search processor configured to perform a cell search on peripheral cells selected based on the acquired regulated states, and a cell selector configured to select a handover destination cell based on a result of the cell search, thus making it possible to suppress a load on a base station of a process to avoid congestion.

### TECHNICAL FIELD

The present invention relates to a mobile station device, a base station device, a communication method, and a program.

Priority is claimed on Japanese Patent Application No. 2012-145461, filed Jun. 28, 2012, the content of which is incorporated herein by reference.

### BACKGROUND ART

As a countermeasure to congestion due to concentration of access from terminals to a particular base station, there is a technique disclosed in, for example, the LTE-A (Long Term Evolution-Advanced) standard (for example, Non-Patent Document 1). In this technique, the access to the base station is limited in accordance with an access class of terminals and thereby the number of terminals allowed to access the base station is reduced, thus avoiding the congestion. However, the technique of avoiding congestion by imposing the limitation in accordance with the access class causes a problem that there arises a terminal that cannot access the base station.

As congestion measures to avoid such a problem, there is a method disclosed in Patent Document 1. In this method, in a case where a service cell is simultaneously used among a plurality of different RATs (radio access technologies), access targets for a terminal are not limited to base stations using one RAT, but are expanded to base stations using different RATs, thus dispersing the access targets. Further, load information (resource status) for each RAT in the serving cell is exchanged among base stations using different RATs, thus preventing access from concentrating on the base stations using one RAT, thereby avoiding congestion.

### CITATION LIST

### Patent Document

[Patent Document 1] Japanese Unexamined Patent Application, First Publication No. 2011-234315

### Non-Patent Document

[Non-Patent Document 1] “Consideration on EAB content for LTE”, 3GPP R2-115799

### DISCLOSURE OF THE INVENTION

### Problems to be Solved by the Invention

However, in the technique disclosed in Patent Document 1, it is the base station side that determines a handover destination for the terminal. For this reason, there is a problem that there occurs another load such that the base station side, although in the high-load state due to the congestion, has to perform a task of determining which terminal of a plurality (large number) of terminals in a cell to handover to which cell.

The present invention has been made in view of such circumstances, and provides a mobile station device, a base station device, a communication method, and a program, which can suppress a load on the base station of a process to avoid congestion.

### Means for Solving the Problems

(1) The present invention has been made to solve the above problems. One aspect of the present invention is a mobile station device including: a peripheral regulated state acquirer configured to acquire regulated states of peripheral cells; a cell search processor configured to perform a cell search on peripheral cells selected based on the acquired regulated states; and a cell selector configured to select a handover destination cell based on a result of the cell search.

(2) Additionally, regarding the mobile station device according to another aspect of the present invention, the peripheral regulated state acquirer is configured to receive broadcast information regarding a camping cell, and to acquire the regulated states of the peripheral cells from the broadcast information.

(3) Further, regarding the mobile station device according to another aspect of the present invention, the cell search processor is configured to determine, based on the regulated states, whether or not communication to be performed by the mobile station device or communication currently performed by the mobile station device is subject to a regulation, and to perform a cell search on a peripheral cell for which the communication is determined not to be subject to the regulation.

(4) Moreover, regarding the mobile station device according to another aspect of the present invention, the cell search processor is configured to perform the cell search in a case that communication to be performed by the mobile station device is subject to a regulation in a camping cell, or in a case that communication currently performed by the mobile station device becomes subject to the regulation in the camping cell.

(5) Additionally, another aspect of the present invention is a base station device including: a peripheral regulated state acquirer configured to acquire regulated states of peripheral cells; a broadcast information generator configured to generate broadcast information including information indicating the acquired regulated states of the peripheral cells; and a wireless transmitter configured to wirelessly transmit the generated broadcast information.

(6) Further, the base station device according to another aspect of the present invention further includes: a regulated state notifier configured to transmit to another device, information indicating a regulated state of the base station device. The peripheral regulated state acquirer is configured to receive from the other device, information indicating the regulated states of the peripheral cells.

(7) Moreover, another aspect of the present invention is a communication method including: a first step of acquiring regulated states of peripheral cells; a second step of performing a cell search on peripheral cells selected based on the acquired regulated states; and a third step of selecting a handover destination cell based on a result of the cell search.

(8) Additionally, another aspect of the present invention is a communication method including: a first step of acquiring regulated states of peripheral cells; a second step of generating broadcast information including information indicating the acquired regulated states of the peripheral cells; and a third step of wirelessly transmitting the generated broadcast information.

(9) Further, another aspect of the present invention is a program to have a computer of a mobile station device function as: a peripheral regulated state acquirer configured to acquire regulated states of peripheral cells; a cell search processor configured to perform a cell search on peripheral cells selected based on the acquired regulated states; and a cell selector configured to select a handover destination cell based on a result of the cell search.

(10) Moreover, another aspect of the present invention is a program to have a computer of a base station device function as: a peripheral regulated state acquirer configured to acquire regulated states of peripheral cells; a broadcast information generator configured to generate broadcast information including information indicating the acquired regulated states of the peripheral cells; and a wireless transmitter configured to wirelessly transmit the generated broadcast information.

### Effects of the Invention

According to the present invention, it is possible to suppress a load on the base station of a process to avoid congestion.

### BRIEF DESCRIPTION OF THE DRAWINGS

FIG. 1 is a schematic block diagram showing a configuration of a communication system 100 according to one embodiment of the present invention.

FIG. 2 is a schematic block diagram showing a configuration of eNB 102a according to the embodiment.

FIG. 3 is a schematic block diagram showing a configuration of NodeB 106a according to the embodiment.

FIG. 4 is a schematic block diagram showing a configuration of UE 107 according to the embodiment.

FIG. 5 is a diagram showing an example of a format of peripheral cell information included in broadcast information.

FIG. 6 is a diagram showing an example of a format of information indicating a regulated state to be included in an IntraFreqNeighCellInfo type.

FIG. 7 is a diagram showing an example of another format of information indicating a regulated state to be included in the IntraFreqNeighCellInfo type.

FIG. 8 is a diagram showing a format of AC-BARRINGConfig type.

FIG. 9 is a diagram showing an example of a format of the peripheral cell information including information indicating the regulated state according to the embodiment.

FIG. 10 is a sequence diagram illustrating operation of a communication system 100 according to the embodiment.

FIG. 11 is another sequence diagram illustrating the operation of the communication system 100 according to the embodiment.

### BEST MODE FOR CARRYING OUT THE INVENTION

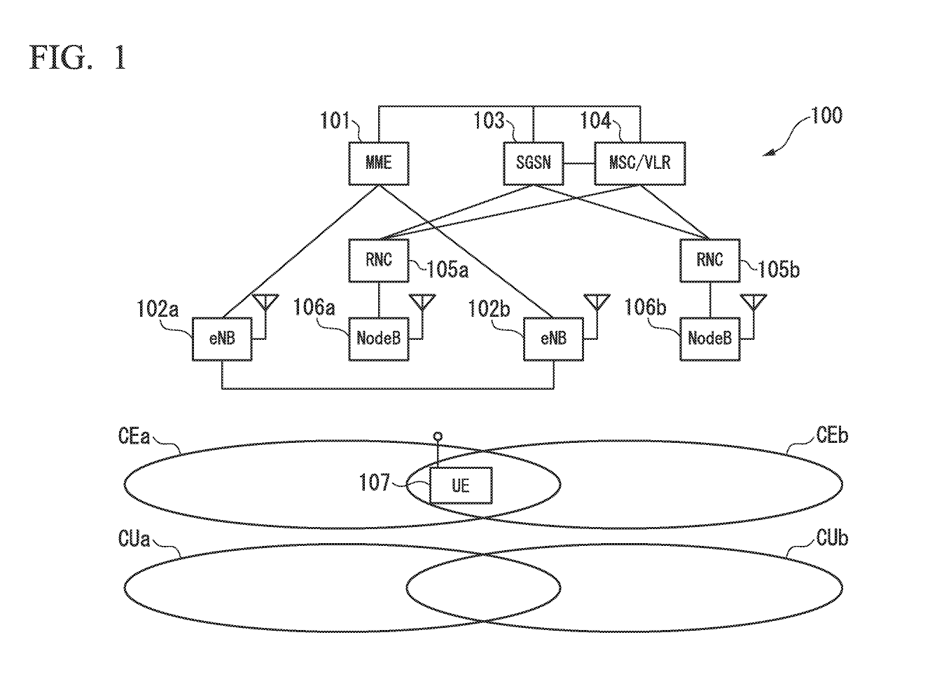

Hereinafter, embodiments of the present invention will be described with reference to drawings. FIG. 1 is a schematic block diagram showing a configuration of a communication system 100 according to one embodiment of the present invention. As shown in FIG. 1, the communication system 100 is configured to include MME 101, eNB 102a, eNB 102b, SGSN 103, MSC/VLR 104, RNC 105a, RNC 105b, NodeB 106a, NodeB 106b, and UE 107. The communication system 100 includes an E-UTRAN (evolved universal terrestrial radio access network), a mobile network including the E-UTRAN, a UTRAN (UMTS (universal mobile telecommunications network) terrestrial radio access network), and a core network including the UTRAN. Further, the mobile network and the core network are accessibly connected to each other.

MME 101 is a mobile management device (mobile management entity) and is disposed in the mobile network. MME 101 manages on which base station (eNB; E-UTRAN Node B) a mobile station device (UE; user equipment) is camping. eNB 102a and eNB 102b are wireless base station devices (eNB; E-UTRAN Node B) and are disposed in the E-UTRAN. eNB 102a and eNB 102b perform wireless communication with UE 107 using RAT (radio access technology) conforming to the LTE-A standard. Further, eNB 102a and eNB 102b are accessibly connected by an X2 interface.

SGSN 103 is a packet switch (SGSN; serving general packet radio service support node), and is disposed in the core network. MSC/VLR 104 is a circuit switch and location register and is disposed in the core network. RNC 105a and RNC 105b are wireless network controllers (radio network controllers) and are disposed in the UTRAN. Additionally, NodeB 106a and NodeB 106b are wireless base station devices (UTRAN Node B) and are disposed in the UTRAN. NodeB 106a and NodeB 106b perform wireless communication with UE 107 using RAT (radio access technology; wireless communication connection technology) conforming to the W-CDMA (registered trademark) standard.

Additionally, UE 107 is a mobile station device and supports both the RAT conforming to the LTE-A standard and the RAT conforming to the W-CDMA (registered trademark) standard. Further, in FIG. 1, cell CEa is a cell served by eNB 102a. Cell CEb is a cell under control of eNB 102b. Cell CUa is a cell under control of NodeB 106a. Cell CUb is a cell under control of NodeB 106b. Cell CEa, cell CEb, cell CUa, and cell CUb are disposed so as to geographically overlap one another. For this reason, cell CEa, cell CEb, and cell CUa are included in peripheral cells of cell CUb. Similarly, cell CEa, cell CEb, and cell CUb are included in peripheral cells of cell CUa. Cell CEa, cell CUa, and cell CUb are included in peripheral cells of cell CEb. Cell CEb, cell CUa, and cell CUb are included in peripheral cells of cell CEa.

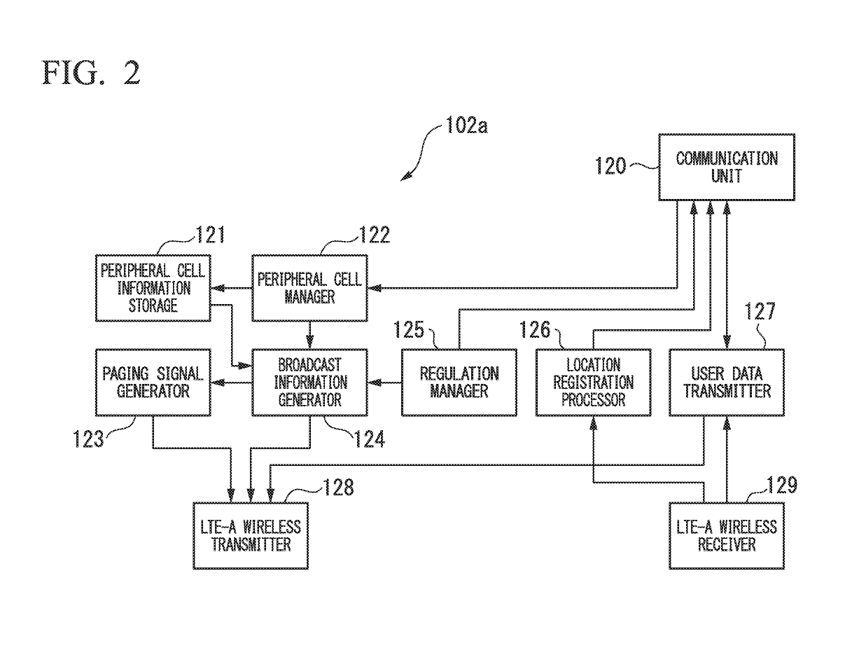

FIG. 2 is a schematic block diagram showing a configuration of eNB 102a. eNB 102b has a configuration similar to that of eNB 102a, and therefore a description thereof will be omitted here. eNB 102a is configured to include a communication unit 120, a peripheral cell information storage 121, a peripheral cell manager 122, a paging signal generator 123, a broadcast information generator 124, a regulation manager 125, a location registration processor 126, a user data transferer 127, an LTE-A wireless transmitter 128, and an LTE-A wireless receiver 129.

The communication unit 120 communicates with MME 101 and another wireless base station (in this case, eNB 102b) disposed in the E-UTRAN. Here, when communicating with another wireless base station disposed in the E-UTRAN, the communication unit 120 may use the X2 interface. The peripheral cell information storage 121 stores peripheral cell information regarding the wireless base station. The peripheral cell information includes a cell ID of each peripheral cell, information indicating a frequency, and information indicating a regulated state. The peripheral cell manager 122 (peripheral regulated state acquirer) has the peripheral cell information storage 121 store information indicating a regulated state of a peripheral cell, which is received by the communication unit 120. Then, the peripheral cell manager 122 requests the broadcast information generator 124 to generate new broadcast information. Here, the communication unit 120 receives the information indicating the regulated state of the peripheral cell, from MME 101 or another wireless base station (in this case, eNB 102b) disposed in the E-UTRAN. Upon receiving the request from the broadcast information generator 124, the paging signal generator 123 generates a paging signal to notify the mobile station device that the broadcast information has been updated. Then, the paging signal generator 123 outputs the generated paging signal to the LTE-A wireless transmitter 128.

Upon receiving a request from the peripheral cell manager 122 or the regulation manager 125, the broadcast information generator 124 generates broadcast information including peripheral cell information stored by the peripheral cell information storage 121 and information indicating a regulated state of the base station managed by the regulation manager 125. At this time, the broadcast information generator 124 requests the paging signal generator 123 to generate a paging signal to notify that the broadcast information has been updated. The broadcast information generator 124 periodically outputs the generated broadcast information to the LET-A wireless transmitter 128.

The regulation manager 125 manages a regulated state of the device itself. Specifically, the regulation manager 125 manages whether the regulated state of the device itself is a regulated state based on an access class in a packet switch domain (PS; packet switch) or a regulated state based on EAB (extended access barring) defined by the LTE-A standard. When there is a change in the regulated state of the device itself, the regulation manager 125 (regulated state notifier) notifies, via the communication unit 120, MME 101 and wireless base stations serving the peripheral cells (here, eNB 102b) disposed in the E-UTRAN of a new regulated state (regulation information change). MME 101 notifies RNC 105a and RNC 105b of the regulation information change via the SGSN 103 and the MSC/VLR 104, and directly notifies other base stations (eNB 102b) thereof. Additionally, when there is a change in the regulated state of the device itself, the regulation manager 125 requests the broadcast information generator 124 to generate new broadcast information.

In accordance with a location registration request that the LTE-A wireless receiver 129 has received from the mobile station device, the location registration processor 126 communicates with MME 101 via the communication unit 120, thereby performing location registration. The user data transferer 127 outputs user data received by the communication unit 120 to the LTE-A wireless transmitter 128 and transfers the user data to the mobile station device. Additionally, the user data transferer 127 outputs user data received by the LTE-A wireless receiver 129 to the communication unit 120 and transfers the user date to a destination device.

Using the RAT conforming to the LTE-A standard, the LTE-A wireless transmitter 128 transmits to the mobile station device, the paging signal output from the paging signal generator 123, the broadcast information output from the broadcast information generator 124, and the user data output from the user data transferer 127. The LTE-A wireless receiver 129 receives the user data transmitted by the mobile station device using the RAT conforming to the LTE-A standard, and the signal indicating the location registration request.

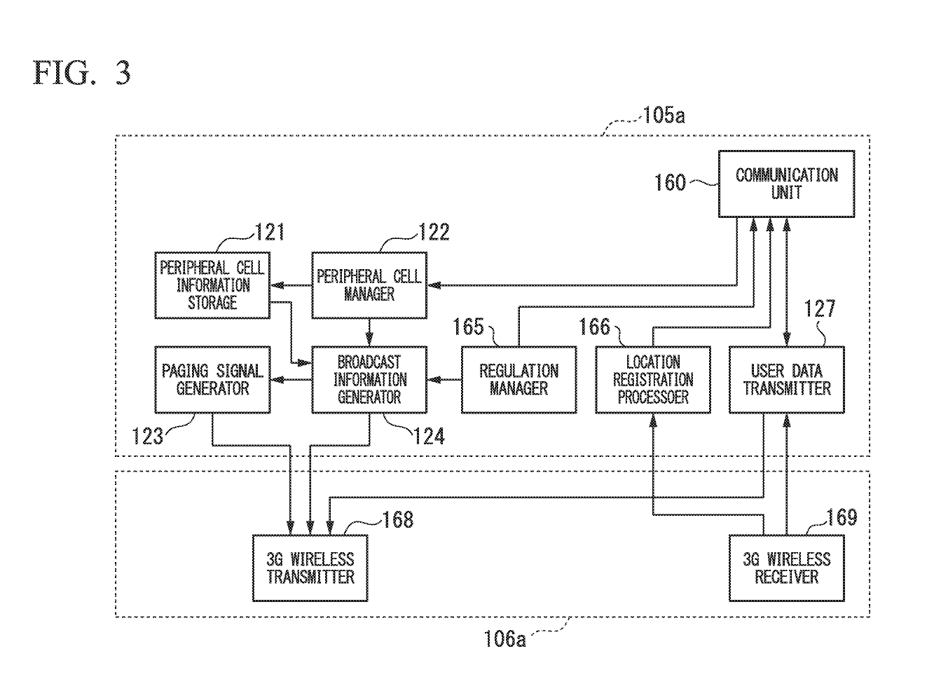

FIG. 3 is a schematic block diagram showing configurations of RNC 105a and NodeB 106a. RNC 105b has a configuration similar to that of RNC 105a, NodeB 106b has a configuration similar to that of NodeB 106a, and therefore description thereof will be omitted here. Additionally, the same reference numerals (121 to 123, 124, and 127) are appended to portions corresponding to the respective units shown in FIG. 2, and description thereof is omitted here. RNC 105a is configured to include a communication unit 160, a peripheral cell information storage 121, a peripheral cell manager 122, a paging signal generator 123, a broadcast information generator 124, a regulation manager 165, a location registration processor 166, and a user data transferer 127. NodeB 106a is configured to include a 3G wireless transmitter 168 and a 3G wireless receiver 169.

The communication unit 160 of RNC 105a communicates with SGSN 103 and MSC/VLR 104. Here, the communication unit 160 receives from SGSN 103, information regarding a circuit switched domain (CS: circuit switch), among information regarding regulated states of peripheral cells. Additionally, the communication unit 160 receives from MSC/VLR 104, information regarding a packet switched domain (PS: packet switch), among the information regarding regulated states of peripheral cells. The regulation manager 165 manages a regulated state of the device itself. Specifically, the regulation manager 165 manages a state of a regulation based on an access class in the circuit-switched domain (CS: circuit switch), and a state of a regulation based on an access class in the packet-switched domain (PS: packet switch).

When there is a change in the regulated state of the device itself, the regulation manager 165 (regulated state notifier), via the communication unit 160, notifies SGSN 103 of new regulated state (regulation information change) information regarding the circuit-switched domain (CS: circuit switch), and notifies MSC/VLR 104 of new regulated state (regulation information change) information regarding the packet switched domain (PS: packet switch). Those regulation information changes are notified to other base stations (eNB 102a, eNB 102b, and NodeB 106b) via SGSN 103 and MSC/VLR 104, and further via other RNC 105b, MME 101, and the like. Additionally, when there is a change in the regulated state of the device itself, the regulation manager 165 requests the broadcast information generator 124 to generate new broadcast information.

In accordance with the location registration request that the 3G wireless receiver 169 has received from the mobile station device, the location registration processor 166 performs communication with SGSN 103 or MSC/VLR via the communication unit 160, thereby performing location registration. The 3G wireless transmitter 168 transmits to the mobile station device, using RAT conforming to the W-CDMA (registered trademark) standard, the paging signal output from the paging signal generator 123, the broadcast information output from the broadcast information generator 124, and the user data output from the user data transferer 127. The 3G wireless receiver 169 receives the user data and the location registration request signal which are transmitted by the mobile station device using the RAT conforming to the W-CDMA (registered trademark) standard.

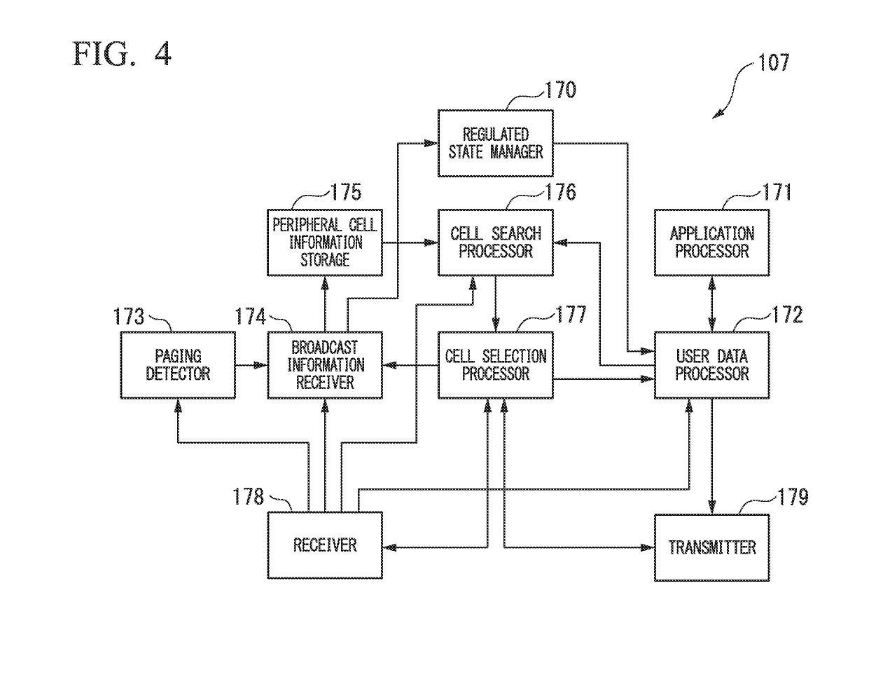

FIG. 4 is a schematic block diagram showing a configuration of UE 107. As shown in FIG. 4, UE 107 is configured to include a regulated state manager 170, an application processor 171, a user data processor 172, a paging detector 173, a broadcast information retriever 174, a peripheral cell information storage 175, a cell search processor 176, a cell selection processor 177, a receiver 178, and a transmitter 179.

The regulated state manager 170 manages a regulated state of a camping cell based on the regulated state retrieved by the broadcast information retriever 174. The application processor 171 executes an application to be used to perform calls, web browsing, transmission and reception of mails, and the like. Additionally, the application processor 171 outputs to the user data processor 172, the user data to be transmitted to another devices, and acquires from the user data processor 172, the user data received from another device.

The user data processor 172 outputs to the transmitter 179, the user data received from the application processor 171, in order to have the transmitter 179 wirelessly transmit the user data. At this time, the user data processor 172 acquires a regulated state of the camping cell from the regulated state manager 170. Then, the user data processor 172 determines whether or not the user data can be transmitted to the camping cell. For example, if the camping cell has set an access class to be regulated in the circuit-switched domain, the user data processor 172 determine that the user data is user data of a telephone call, that is, user data to be transmitted to the circuit-switched domain, and if the access class of UE 107 is subject to the regulation, determines that the user data cannot be transmitted. Alternatively, if the camping cell is imposing access-class-based regulation, and the access class of UE 107 is subject to the regulation, the user data processor 172 determines that the user data cannot be transmitted.

Here, the user data processor 172 performs the above determination at least before transmission of user data is initiated. Additionally, the user data processor 172 performs a similar determination also when the regulated state of the camping cell is changed during transmission of the user data. If it is determined that the user data can be transmitted, the user data processor 172 outputs the user data as it is to the transmitter 179, and has the transmitter 179 transmit the user data. Additionally, it is determined that the user data cannot be transmitted, the user data processor 172 requests the cell search processor 176 to perform a cell search, and waits until receiving from the cell selection processor 177, an instruction to resume transmission of the user data. Here, the user data processor 172 notifies the cell search processor 176 of, along with the request for the cell search, regulation target information used to determine whether or not the transmission of the user data is subject to the regulation in a peripheral cell.

In the present embodiment, as regulated states of peripheral cells, there are a regulation based on an access class using the EAB, a regulation based on an access class with respect to the packet-switched domain, and a regulation based on an access class with respect to the circuit-switched domain. Therefore, the regulation target information includes information indicating whether the user data is to be transmitted to the packet-switched domain or the circuit-switched domain, and information indicating an access class of the device.

The paging detector 173 detects a paging signal from the signal received by the receiver 178. If the detected paging signal indicates update of the broadcast information, the paging detector 173 notifies the broadcast information retriever 174 of the update of the broadcast information. The broadcast information retriever 174 (peripheral regulated state acquirer) retrieves the broadcast information received from the signal receiver 178. Further, the broadcast information retriever 174 has the peripheral cell information storage 175 store peripheral cell information included in the retrieved broadcast information. Moreover, the broadcast information retriever 174 outputs to the regulated state manager 170, information indicating the regulated state of the camping cell, which is included in the retrieved broadcast information.

Here, the broadcast information retriever 174 retrieves broadcast information at the time an update of the broadcast information is notified from the paging detector 173 and at the time an update of the camping cell is notified from the cell selection processor 177. Here, if the base station does not transmit a paging signal even after the regulated state is changed, or if the mobile station is a device subject to a regulation in a regulated state, among the regulated states, where the base station does not transmit a paging signal even after the regulated state is changed, the broadcast information retriever 174 retrieves broadcast information from a reception signal when a request is received from the user data processor 172 at the time of transmission of the user data.

The peripheral cell information storage 175 stores peripheral cell information. Here, the peripheral cell information includes not only information required for a cell search, such as a cell ID and a frequency of each peripheral cell, but also information indicating a regulated state of each peripheral cell. Additionally, the peripheral cell information also includes information regarding a RAT cell different from that used by the camping cell.

Upon receiving the request for a cell search from the user data processor 172, the cell search processor 176 performs a cell search with respect to the peripheral cell selected based on the information indicating a regulated state, which is stored by the peripheral cell information storage 175. Specifically, first, the cell search processor 176 reads from the peripheral cell information storage 175, the information indicating a regulated state of each peripheral cell. Then, the cell search processor 176 checks the information indicating a regulated state of each peripheral cell against the regulation target information acquired from the user data processor 172. Then, the cell search processor 176 select as a target for the cell search, a peripheral cell for which transmission performed by the user data processor 172 is not subject to the regulation. The cell search processor 176 reads from the peripheral cell information storage 175, a cell ID and a frequency of each peripheral cell selected. Based on those information, the cell search processor 176 controls the receiver 178, thereby performing a cell search.

Based on a result of the cell search performed by the cell search processor 176, the cell selection processor 177 (cell selector) determines, for example, a cell with the best reception quality to be a handover destination cell. The cell selection processor 177 notifies the receiver 178 and the transmitter 179 of the RAT used by the handover destination cell. Then, the cell selection processor 177 outputs to the transmitter 179, a location registration request addressed to the handover destination cell, in order to have the transmitter 179 transmit the location registration request. When the location registration is completed, the cell selection processor 177 instructs the user data processor 172 to resume transmission of the user data. Additionally, the cell selection processor 177 notifies the broadcast information retriever 174 that the camping cell has been updated.

The receiver 178 receives signals transmitted by base station devices (here, eNB 102a, eNB 102b, NodeB 106a, and NodeB 106b). Here, the receiver 178 performs on the received signal, a process in accordance with the RAT notified from the cell selection processor 177. The transmitter 179 transmits to the base station devices (here, eNB 102a, eNB 102b, NodeB 106a, and NodeB 106b), the user data output from the user data processor 172. Here, the transmitter 179 performs on the user data, a process in accordance with the RAT notified from the cell selection processor 177, thus generating a signal to be transmitted.

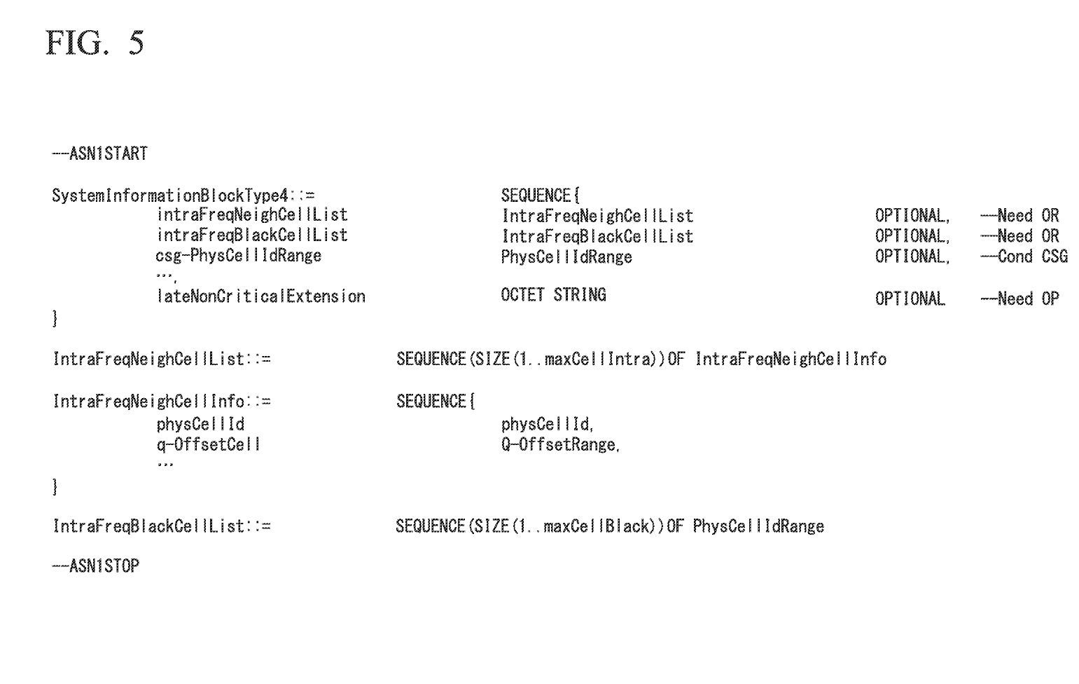

FIG. 5 is a diagram showing an example of a format of the peripheral cell information included in the broadcast information. The example shown in FIG. 5 is an excerpt from 3GPP TS36.311 V10.1.0, and is a SystemInformationBlockType4 for the E-UTRAN. In the example of the format shown in FIG. 5, inraFreqNeighCellList represents a list of peripheral cell informations regarding peripheral cells with the same frequency. Then, inraFreqNeighCellList is a sequence of IntraFreqNeighCellInfo type. Each IntraFreqNeighCellInfo type includes a physCellId that is a cell ID. In the present embodiment, this IntraFreqNeighCellInfo type includes information indicating a regulated state.

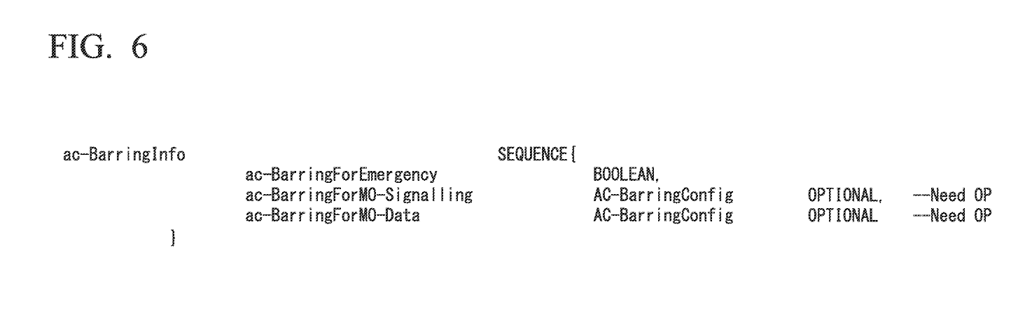

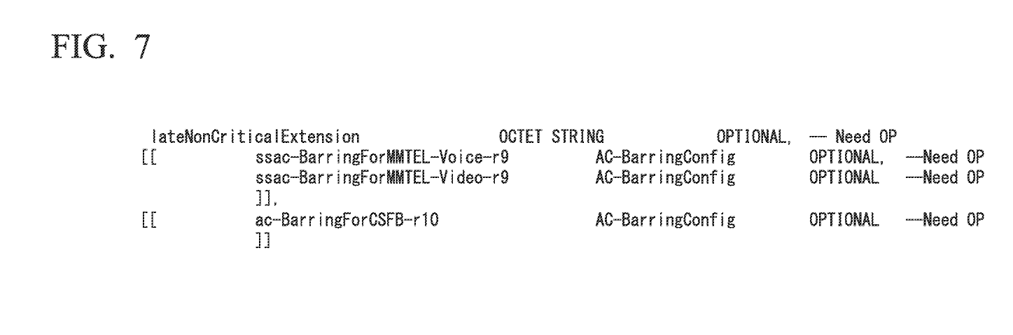

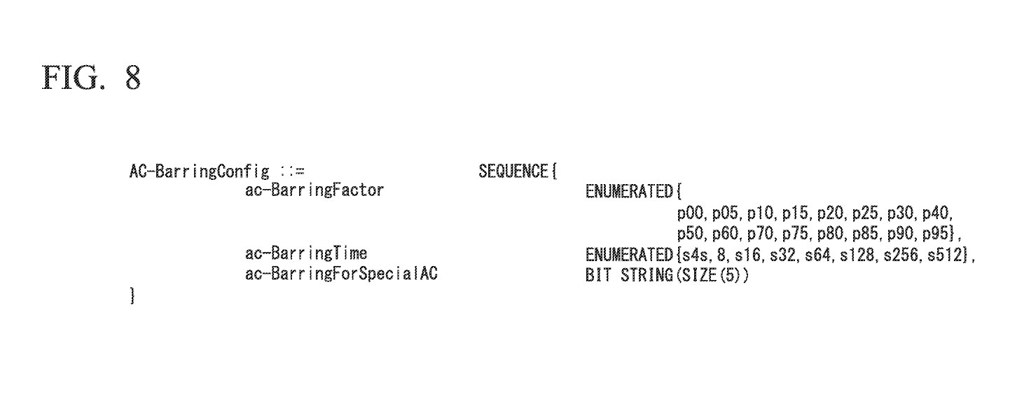

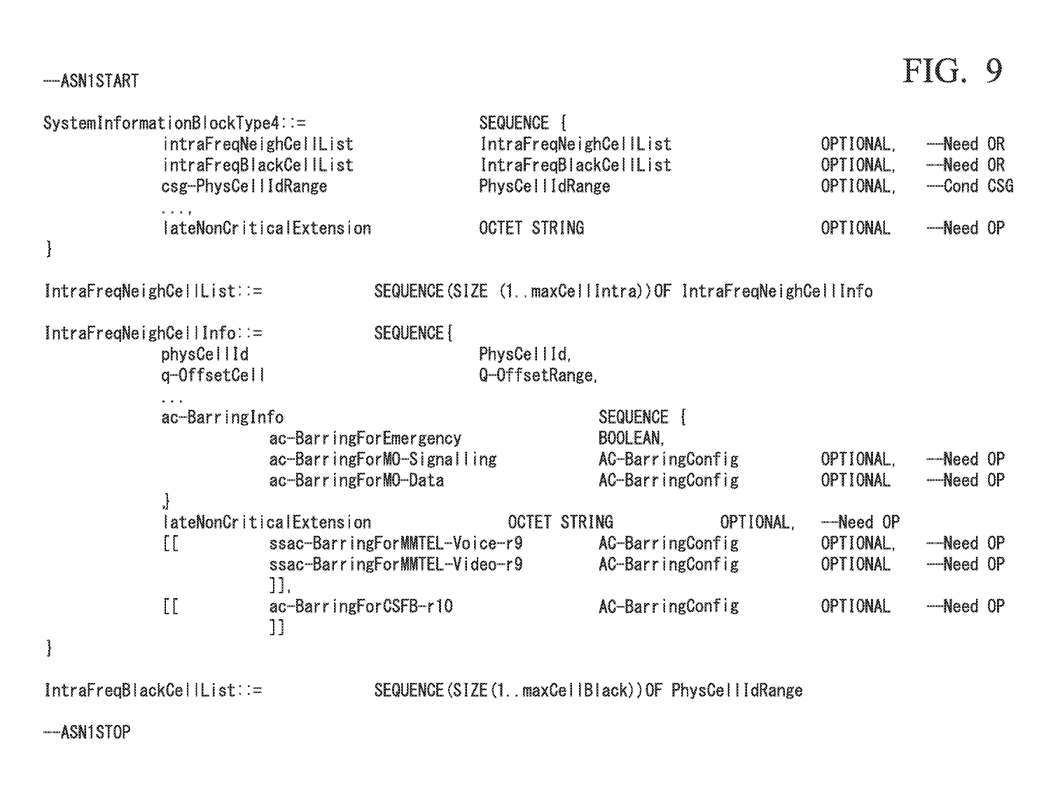

FIG. 6 is a diagram showing an example of a format of information indicating a regulated state to be included in the IntraFreqNeighCellInfo type. Additionally, FIG. 7 is a diagram showing an example of another format of information indicating a regulated state to be included in the IntraFreqNeighCellInfo type. FIG. 8 shows an AC-BARRINGConfig type shown in FIG. 6 and FIG. 7. In summary, the AC-BARRINGInfo type and LateNonCritecalExtension type are included in the IntraFreqNeighCellInfo type of the peripheral cell information, as shown in FIG. 9, thus making it possible to include regulated states of those cells in the peripheral cell information.

Here, the case of the peripheral cells with the same frequency has been described. However, a format to describe peripheral cell information is similarly defined for peripheral cells with different frequencies (Inter-Frequency) and peripheral cells using different RATs, such as the UTRAN. Therefore, information indicating a regulated state is inserted in a similar manner.

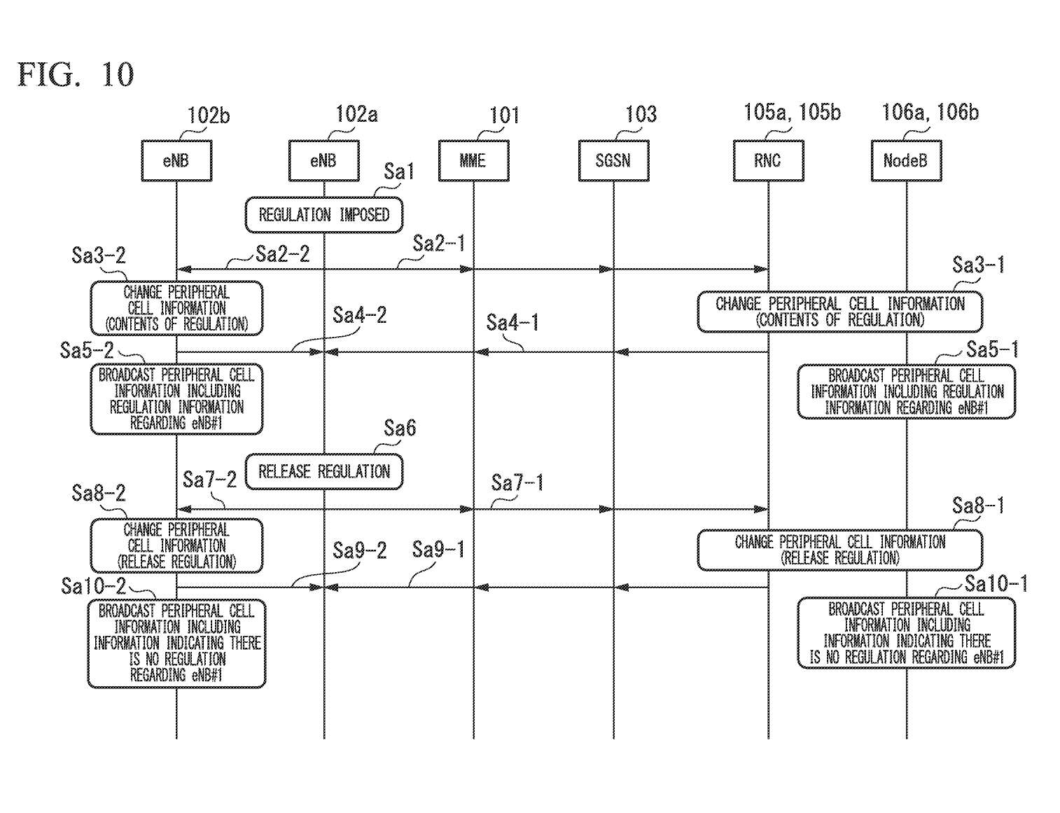

FIG. 10 is a sequence diagram showing operation of the communication system 100. The sequence diagram shown in FIG. 10 shows an example of operation when the regulated state is changed in eNB 102a. When a regulation is generated in eNB 102a (Sa1), the regulation manager 125 transmits a regulation information change indicating the generated regulated state, via the communication unit 120, to the MME 101 and a peripheral cell (eNB 102b) accessible via the X2 interface (Sa2-1 and Sa2-2). MME 101 transfers this regulation information change to SGSN 103. SGSN 103 transfers the regulation information change to RNC 105a and RNC 105b. RNC 105a and RNC 105b transfer the regulation information change respectively to NodeB 106a and NodeB 106b (Sa2-1).

The peripheral cell manager 122 of each base station (eNB 102b, NodeB 106a, and NodeB 106b) having received the regulation information update, in accordance with this regulation information update, changes the information indicating the regulated state, which is included in the peripheral cell information regarding eNB 102a, stored by the peripheral cell information storage 121 (Sa3-1, Sa3-2). Then, as a response thereto, the peripheral cell manager 122 transmits a regulation information change response in the reverse path (Sa4-1, Sa4-2). Additionally, each of the broadcast information generators 124 of the respective base stations (eNB 102b, NodeB 106a, and NodeB 106b) generates broadcast information including information indicating the updated regulated state. Then, the generated broadcast informations are transmitted via the wireless transmitters of the respective base stations (the LTE-A wireless transmitter 128, the 3G wireless transmitter 168) (Sa5-1, Sa5-2).

Then, when the regulation on eNB 102a is released (Sa6), the regulation manager 125 of eNB 102a transmits via the communication unit 120 to MME 101 and a peripheral cell (eNB 102b) accessible via the X2 interface, a regulation information change indicating that the regulated state has been released (Sa7-1, Sa7-2). MME 101 transfers this regulation information change to SGSN 103. SGSN 103 transfers this regulation information change to RNC 105a and RNC 105b. RNC 105a and RNC 105b transfer this regulation information change respectively to NodeB 106a and NodeB 106b (Sa7-1).

The peripheral cell manager 122 of each base station (eNB 102b, NodeB 106a, and NodeB 106b) having received the regulation information update, in accordance with this regulation information update, changes the information indicating the regulated state, which is included in the peripheral cell information regarding eNB 102a, stored by the peripheral cell information storage 121 (Sa8-1, Sa8-2). In other words, the peripheral cell manager 122 changes the stored information to information indicating that the regulation has been released. Then, as a response thereto, the peripheral cell manager 122 transmits a regulation information change response in the reverse path (Sa9-1, Sa9-2). Additionally, each of the broadcast information generators 124 of the respective base stations (eNB 102b, NodeB 106a, and NodeB 106b) generates broadcast information including information indicating that the regulation has been released. Then, the generated broadcast informations are transmitted from the wireless transmitters of the respective base stations (LTE-A wireless transmitters 128, 3G wireless transmitters 168) (Sa10-1, Sa10-2).

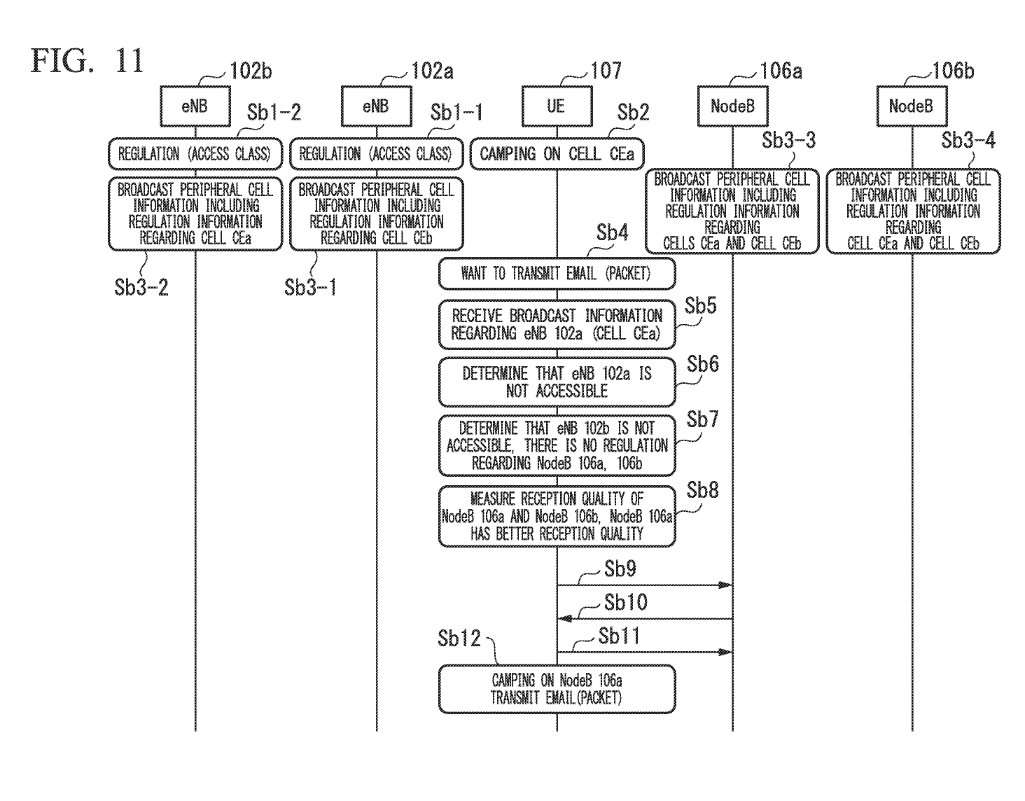

FIG. 11 is another sequence diagram illustrating the operation of the communication system 100. The sequence diagram shown in FIG. 11 shows an example of operation when UE 107 performs packet transmission. First, both eNB 102a and eNB 102b are respectively subjected to access-class-based regulations in the cell CEa and the cell CEb (Sb1-1, Sb1-2). Additionally, UE 107 is camping on the cell CEa served by eNB 102a (Sb2). eNB 102a, eNB 102b, NodeB 106a, and NodeB 106b are transmitting broadcast information (Sb3-1, Sb3-2, Sb3-3, and Sb3-4). At this time, the broadcast information broadcast from eNB 102a includes peripheral information indicating that regulation is generated in the cell CEb. The broadcast information broadcast from eNB 102b includes peripheral information indicating that a regulation has been generated in the cell CEa. Broadcast informations broadcast from NodeB 106a and NodeB 106b include peripheral informations indicating that regulations have been generated in the cell CEa and the cell CEb, respectively.

In such a state, the application processor 171 of UE 107 performs transmission of an e-mail (packet) (Sb4). The user data processor 172 of UE 107 acquires from the application processor 171, user data to be used to transmit that e-mail. Then, the broadcast information retriever 174 of UE 107 receives via the receiver 178, the broadcast information regarding the camping cell CEa (eNB 102a) (Sb5). The broadcast information retriever 174 retrieves peripheral cell information from the broadcast information, and has the peripheral cell information storage 175 store the retrieved peripheral cell information. Additionally, the broadcast information retriever 174 retrieves from the broadcast information, the information indicating the regulated state of the camping cell CEa. Then, the broadcast information retriever 174 notifies the regulated state manager 170 of the retrieved information. Here, an example is taken with respect to a case where a paging signal is not transmitted even after the regulated state is changed. When the regulated state is changed, if a paging signal is transmitted, reception of broadcast information may be performed only when the broadcast signal is notified by the paging signal. In this case, the regulated state of each cell stored by the regulated state manager 170 and the peripheral cell information storage 175 is the latest. For this reason, at the time of transmission of user data, the following determination is performed using those informations.

The user data processor 172 acquires from the regulated state manager 170, information indicating the regulated state of the camping cell CEa, and determines whether or not transmission of an e-mail is available. Here, it is assumed that UE 107 is subject to an access-class-based regulation in the cell CEa. For this reason, the user data processor 172 determines that transmission of an e-mail is not available (access unavailable) (Sb6). Then, the user data processor 172 requests the cell search processor 176a to perform a cell search. The cell search processor 176 refers to the peripheral cell information stored by the peripheral cell information storage 175. Thus, the cell search processor 176 determines that the cell CEb served by eNB 102b is not accessible due to the regulated state, and that the cell CUa and the cell CUb respectively served by NodeB 106a and NodeB 106b are subject to no regulation and therefore are accessible (Sb7).

The cell search processor 176 performs a cell search (measurement of the reception quality) on the cell CUa and the cell CUb determined to be accessible. Comparing results of the cell search, the cell selection processor 177 selects a cell with the better reception quality (here, the cell CUa) (Sb8). The cell selection processor 177 transmits via the transmitter 179, a location registration request signal addressed to NodeB 106a that is a base station serving the selected cell CUa (Sb9). Here, prior to the transmission, the cell selection processor 177 instructs the transmitter 179 and the receiver 178 about the W-CDMA (registered trademark) that is the RAT used in the cell CUa. Additionally, Routing Area Update is used as a location registration request.

This is because this is the case of transmission of an e-mail (packet), and therefore handover is performed from the cell CEa that is an E-UTRA cell to the packet-switched domain of the cell CUa that is a UTRAN cell. In a case of handover to a E-UTRA cell, Tracking Area Update is used as a location registration request. Additionally, in a case of handover to PS/CS Combined of an UTRAN cell, Routing Area Update is used. In a case of handover to the packet-switched domain of a UTRAN cell, Location Update is used.

The location registration processor 126 of NodeB 106a having received the location registration request signal via the 3G wireless receiver 169 transfers the location registration request signal to RNC 105a via the communication unit 160. Additionally, upon receiving from the RNC 105a via the communication unit 160, a location registration response signal as a response to the location registration request signal, the location registration processor 126 transfers the location registration response signal to UE 107 via the 3G wireless transmitter 168 (Sb10). Upon receiving the location registration response signal via the receiver 178, the cell selection processor 177 of UE 107 transmits a location registration completion signal to NodeB 106 via the transmitter 179 (Sb11).

Thus, UE 107 camps on the cell CUa. Therefore, the cell selection processor 177 instructs the user data processor 172 to resume transmission of user data. The user data processor 172 having received the instruction outputs to the transmitter 179, user data to be used to transmit an e-mail, and has the user NodeB 106 transmit the user data (Sb12).

Here, a sequence for handover to a peripheral cell, which is triggered by transmission of an e-mail from UE107, has been shown in FIG. 11. The sequences after the sequence Sb7 may be performed regarding as a trigger that a paging signal indicating a broadcast information update is notified from eNB 102, broadcast information is received, and a regulation imposed on the camping cell is detected.

Thus, the mobile station side performs a cell search on a peripheral cell selected based on the regulated state of each peripheral cell, and determines a handover-destination cell. Therefore, it is possible to perform a process for avoiding congestion while suppressing the load on the base station side. At this time, the handover-destination cell is selected based on peripheral cells targeted for the cell search and on regulated states of the peripheral cells, thus making it possible to prevent the mobile station device from being subject to a regulation in the handover-destination cell.

Additionally, part or whole of MME 101, eNB 102a, SGSN 103, MSC/VLR 104, RNC 105a, NodeB 106a, and UE 107, which are shown in FIG. 1, may be implemented typically as an LSI that is an integrated circuit. Each functional block of MME 101, eNB 102a, SGSN 103, MSC/VLR 104, RNC 105a, NodeB 106a, and UE 107 may be individually made into a chip. Alternatively, part or whole of the functional blocks may be integrated and made into a chip. Additionally, the method of forming an integrated circuit is not limited to LSI, and an integrated circuit may be implemented by a dedicated circuit or a general-purpose processor. The integrated circuit may be any one of hybrid and monolithic integrated circuits. Functions of the integrated circuit may be implemented in part by hardware or software.

Further, if technology of forming an integrated circuit, which replaces LSI, arises as a result of advances in semiconductor technology, an integrated circuit formed by that technology may be used.

Moreover, a program for implementing part or whole of the functions of MME 101, eNB 102a, SGSN 103, MSC/VLR 104, RNC 105a, NodeB 106a, and UE 107, which are shown in FIG. 1, may be recorded on a computer-readable recording medium, so that a computer system can read and execute the program recorded on the recording medium to implement those devices. Here, the “computer system” may include an OS and hardware such as peripheral devices.

Additionally, the “computer-readable recording medium” means a storage device, such as: a portable medium, for example, a flexible disk, a magneto optical disk, a ROM, or a CD-ROM; or a hard disk built in a computer system. Further, the “computer-readable recording medium” may also include a medium that dynamically stores a program for a short period, such as a communication line in a case where the program is transmitted via a network such as the Internet, or a communication line such as a telephone line. Moreover, the “computer-readable recording medium” may also include a medium that temporarily stores a program, such as a volatile memory included in a computer system which serves as a server or client in the above case. Additionally, the above program may be a program for implementing part of the above-described functions. Further, the above program may be a program that can implement the above-described functions in combination with the program already stored in the computer system.

As described above, the embodiments of the present invention have been described in detail with reference to the drawings, a specific configuration is not limited to those embodiments, and various design modifications may be made without departing from the scope of the invention.

### DESCRIPTION OF REFERENCE NUMERALS

100: communication system
101: MME
102a, 102b: eNB
103: SGSN
104: MSC/VLR
105a, 105b: RNC
106a, 106b: NodeB
107: UE
120, 160: communication unit
121: peripheral cell information storage
122: peripheral cell manager
123: paging signal generator
124: broadcast information generator
125, 165: regulation manager
126, 166: location registration processor
127: user data transferer
128: LTE-A wireless transmitter
129: LTE-A wireless receiver
168: 3G wireless transmitter
169: 3G wireless receiver
170: regulated state manager
171: application processor
172: user data processor
173: paging detector
174: broadcast information retriever
175: peripheral cell information storage
176: cell search processor
177: cell selection processor
178: receiver
179: transmitter

1-10. (canceled)

11. A mobile station device comprising:
a peripheral regulated state acquirer configured to acquire regulated states of peripheral cells;
a cell search processor configured to perform a cell search on peripheral cells selected based on the acquired regulated states; and
a cell selector configured to select a handover destination cell based on a result of the cell search, without transmitting the result of the cell search.

12. The mobile station device according to claim 11, wherein the peripheral regulated state acquirer is configured to receive broadcast information regarding a camping cell, and to acquire the regulated states of the peripheral cells from the broadcast information.

13. The mobile station device according to claim 11, wherein the cell search processor is configured to determine, based on the regulated states, whether or not communication to be performed by the mobile station device or communication currently performed by the mobile station device is subject to a regulation, and to perform a cell search on a peripheral cell for which the communication is determined not to be subject to the regulation.

14. The mobile station device according to claim 13, wherein the cell search processor is configured to perform the cell search in a case that communication to be performed by the mobile station device is subject to a regulation in a camping cell, or in a case that communication currently performed by the mobile station device becomes subject to the regulation in the camping cell.

15. A base station device comprising:
a peripheral regulated state acquirer configured to acquire regulated states of peripheral cells;
a broadcast information generator configured to generate broadcast information including information indicating the acquired regulated states of the peripheral cells;
a wireless transmitter configured to wirelessly transmit the generated broadcast information; and
a receiver configured to, without receiving a result of a cell search performed by the mobile station device, receive a location registration request signal for the mobile station device to request another base station device to perform location registration.

16. The base station device according to claim 15, further comprising:
a regulated state notifier configured to transmit to another device, information indicating a regulated state of the base station device, and
wherein the peripheral regulated state acquirer is configured to receive from the other device, information indicating the regulated states of the peripheral cells.

17. A communication method comprising:
a first step of acquiring regulated states of peripheral cells;
a second step of performing a cell search on peripheral cells selected based on the acquired regulated states; and
a third step of selecting a handover destination cell based on a result of the cell search, without transmitting the result of the cell search.

18. A communication method comprising:
acquiring regulated states of peripheral cells;
generating broadcast information including information indicating the acquired regulated states of the peripheral cells;
wirelessly transmitting the generated broadcast information; and
without receiving a result of a cell search performed by the mobile station device, receiving a location registration request signal for the mobile station device to request another base station device to perform location registration.

19. A non-transitory computer-readable recording medium storing a program to have a computer of a mobile station device perform:
acquiring regulated states of peripheral cells;
performing a cell search on peripheral cells selected based on the acquired regulated states; and
selecting a handover destination cell based on a result of the cell search, without transmitting the result of the cell search.

20. A non-transitory computer-readable recording medium storing a program to have a computer of a base station device perform:
acquiring regulated states of peripheral cells;
generating broadcast information including information indicating the acquired regulated states of the peripheral cells;
wirelessly transmitting the generated broadcast information; and
without receiving a result of a cell search performed by the mobile station device, receiving a location registration request signal for the mobile station device to request another base station device to perform location registration.
